(19) United States
(12) Patent Application Publication
(10) Pub. No.: US 2004/0125073 A1
(43) Pub. Date: Jul. 1, 2004

(54) Portable electronic apparatus and method employing motion sensor for function control

(76) Inventors: Scott Potter, Coconut Creek, FL (US); Joseph Guy Gillette, Margate, FL (US); Sivakumar Muthuswamy, Plantation, FL (US)

Correspondence Address: VEDDER PRICE KAUFMAN & KAMMHOLZ, 222 N. LASALLE STREET, CHICAGO, IL, 60601, US

(21) Appl. No.: 10/331,497

(22) Filed: Dec. 30, 2002

(51) Int. Cl. G09G 5/00

(52) U.S. Cl. 345/156

(57) ABSTRACT

A portable electronic apparatus (500) employs an enclosed motion sensor (120) to detect movement of at least a portion of the portable electronic apparatus using the enclosed motion sensor (120) and controls desired functions such as movement of a pointer (116) on a display, control of menu selections or any other desired function(s), in response to detected movement of at least a portion of the portable electronic apparatus. In one example, the enclosed motion sensor (120) includes an accelerometer located inside a housing of the portable electronic apparatus that detects a rate and direction of movement of the apparatus with respect to a gravitational reference point. A pointer control circuit (200) controls movement of the pointer (116) on the display (110) as a function of the detected rate and direction of apparatus movement to navigate through a user interface on the display (110).

### FIELD OF THE INVENTION

The invention relates generally to interactive control devices and methods and more particularly to methods and devices for interacting with portable electronic devices.

### BACKGROUND OF THE INVENTION

A user function control device, such as a mouse or other device, allows a user to navigate through windows or screens of a graphic user interface, point to a position on a screen to interactively position a cursor or select a position on a display surface, such as a display screen or other suitable surface. Such function control devices are known to be used in desktop computers, portable devices, including for example, laptop computers, cell phones, personal digital assistants (PDAs), Internet appliances and other devices. The pointer on a display may be textual (e.g., highlighted text) or graphical (e.g., cursor).

User interfaces on portable consumer electronic products are getting more complex. This complexity generally requires more controls for the user to manipulate. However, consumer demands typically require products that are small and compact. It can be difficult to include sufficient controls and still keep the device small enough for consumer acceptance. There is also a practical limit on how small controls, such as buttons, may be placed with respect to each other and still remain operable by an average user's finger.

Two major classes of function control devices and exist on portable consumer electronic products, namely one dimensional and two dimensional pointing devices. A one dimensional pointing device may include a mouse, such as a wheel-based mouse, multi-position toggle switches and rocker switches. These pointing devices are manipulated by a user's finger and used to select movement in one dimension in a user interface, such as a graphical user interface, or other suitable interface, in generally one of an up/down, forward/back and next/previous position.

One dimensional pointing devices, such as wheels, can be constructed to use very little of a limited surface area of a product. For example, a wheel may be extended through a slot opening and permit a user to roll the wheel in both directions by dragging a finger along the wheel edge tangent to its circumference. A disadvantage of such wheels is that the slot openings permit contaminants to enter the product.

Toggle switches and rockers are typically larger than wheels, and they require a surface area pad large enough to receive a user's fingertip. In some cases, rocker switches are implemented as two adjacent buttons linked by a common button bar. However, such devices have moving parts and can take up larger surface areas of the device.

Two dimensional pointing devices include, for example, track pads, track balls, joy sticks or other devices. These pointing devices are manipulated by a user's finger and are typically used to select movement in two dimensions simultaneously within a user interface. Any two dimensional pointing device can also be used as a one dimensional pointing device if desired.

Track pads are flat surface areas that sense the absolute contact location of the user's fingertip on the flat surface area. A minimum size of a track pad must therefore be somewhat larger than a user's fingertip to be effective. However, due to the amount of area that they require, they are not typically common on smaller products like handheld devices.

Track balls utilize a rolling sphere to provide a relative motion indication output for a user interface. The minimum diameter of a track ball is constrained by, for example, the size of the sensing apparatus used to determine rotation. However, many portable consumer electronic products do not have the necessary depth to accommodate a track ball pointing device and related sensing mechanisms. In addition, user manipulated track balls are externally exposed on a device and can permit contaminants to enter the product.

Joy sticks are typically not used in portable consumer electronic products, typically because they must project above the surface of the product and they can generally require significant volume within the product for the sensing mechanisms. A variant of a joy stick, commonly referred to as a joybutton, is usually implemented as a two-dimensional rocker switch.

Another prior art mouse implementation requires a fine optical pattern or grid printed on a mouse pad surface on which the user slides an optical mouse. The optical mouse senses the relative motion of the known grid underneath it and uses that information to sense direction and speed. However, the additional grid surface is typically hard to keep clean and free from damage and an external mouse must be used.

Another type of optical mouse such as an IntelliEye Optical Sensor™ marketed by Microsoft Corporation of Redmond, Wash. uses optical sensors and image processing techniques to determine relative motion of the mouse as manipulated by a user and does not require a separate optical grid pad. This product uses a plurality of sensor arrays in an image processor to determine speed and direction of motion from a bottom of the mouse and senses a flat smooth surface below. The sensor arrays are positioned on a bottom surface of the optical mouse. A flat sensing window on the bottom of the mouse receives light for optical sensors. In operation, a flat area, such as the top of a desk, that exceeds the size of a user's palm size is generally required to use the mouse. Again, however, such an optical mouse is a separate large device that is held in the user's hand and is not typically suitable for a portable device. In addition, such a device requires movement of the mouse over a flat surface external to the device to which it is connected and typically has larger sensor spacing.

Most menu/browser navigation systems use directional buttons or simplified joystick input devices. However, they can be expensive, awkward to use, or can take up large spaces on portable electronic devices that are handheld or otherwise have limited surface space to accommodate additional user manipulated mechanisms. As such, an improved display pointing device for portable electronic devices would be desirable.

### BRIEF DESCRIPTION OF THE DRAWINGS

The present invention is illustrated by way of example, and not limitation, in the accompanying figures, in which like reference numerals indicate similar elements, and in which:

FIG. 1 is a perspective view of one example of a portable electronic apparatus in accordance with one embodiment of the invention;

FIG. 2 is a block diagram illustrating one example of a portable electronic apparatus in accordance with one embodiment of the invention;

FIG. 3 is a flow-chart illustrating one example of a method for providing pointer control for a portable electronic apparatus in accordance with one embodiment of the invention;

FIG. 4 is another example of a portable electronic apparatus in accordance with one embodiment of the invention;

FIG. 5 is a functional block diagram illustrating one example of a portable electronic apparatus in accordance with one embodiment of the invention; and

FIG. 6 is a flow-chart illustrating one example of a method for providing function control for a portable electronic apparatus in accordance with one embodiment of the invention.

### DETAILED DESCRIPTION OF THE PREFERRED EMBODIMENT

A portable electronic apparatus, such as a cell phone, laptop, PDA, Internet appliance, or other suitable portable device employs a motion sensor to detect movement of at least a portion of the portable electronic apparatus using the motion sensor and controls a desired function associated with the device in response to movement of the housing. In one example, a function control circuit receives a function control signal from the motion sensor in response to a detected motion of the housing and controls, for example, a pointer on a display or a non-pointer based function, such as, but not limited to, a “click” operation of a point and click technique, turning the device on or off, window control (e.g., enlarging or minimizing windows, providing gaming controls, open an application, move forward or backward in a web browser), or any other suitable function control.

In one example, the motion sensor includes an accelerometer located inside a housing of the portable electronic apparatus that detects a rate and direction of movement of the apparatus with respect to a gravitational reference point. A pointer control circuit controls movement of a pointer on the display as a function of the detected rate and direction of apparatus movement. As such, moving for example a handheld telephone closer to or away from a user is used to navigate through a user interface on a display.

In addition, in one example, a depressible pointer activation button is located on a bottom surface of the housing and protrudes from the bottom surface of the housing so that pushing down on the portable electronic apparatus on a hard surface activates the depressible pointer activation button to provide a point and click navigation system in combination with the enclosed motion sensor.

In an alternative embodiment, a pointer activation surface, which may include, for example, a depressible button, a flat touch activation surface or any other activation mechanism, is located on a side surface of the housing so that a click and point mechanism is provided so that a user of a handheld device need not place the portable electronic apparatus on a hard surface, but instead may manipulate activation of the pointer by pressing the side button and moving the apparatus in the air to facilitate movement of a cursor. As such, a virtual mouse mechanism is provided for navigating menus on portable electronic devices, which mechanism reduces the use of premium surface area on the front of a portable electronic apparatus and removes the need for a user's finger to manipulate small mechanical objects or other surfaces to control movement of a pointer on a display. Other advantages will be recognized by those of ordinary skill in the art.

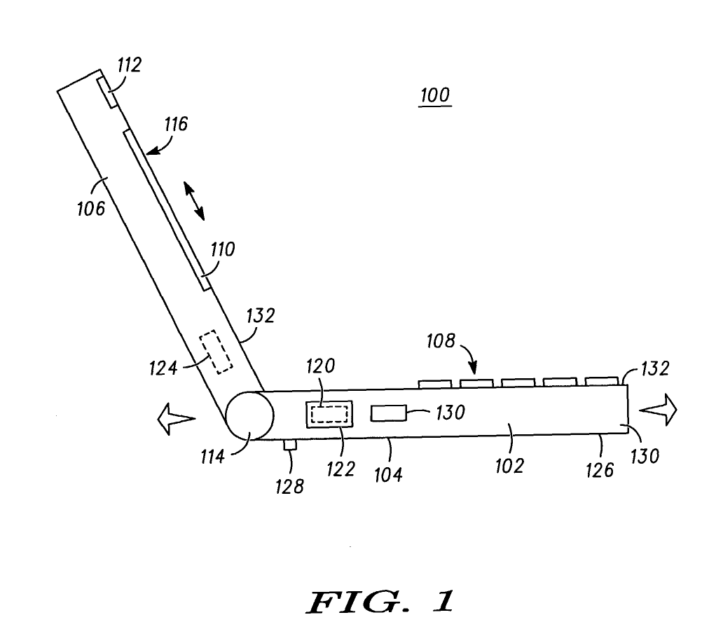

FIG. 1 illustrates one example of a portable electronic apparatus 100 that includes a housing 102 having two main sections, namely a base portion 104 and a flip portion 106. It will be understood that although the portable electronic apparatus 100 is shown as a flip style cell phone, any suitable portable electronic apparatus may be used, such as, but not limited to, monolith cell phones, PDAs, Internet appliances, laptop devices, PC tablet style computers, MP3 players, or any suitable device or combination of these or any suitable portable electronic apparatus. Internet appliances include, for example handheld or portable devices that can access the Internet. The use of a flip style cell phone is merely used for purposes of illustration only. The portable electronic apparatus 100 is shown to be a handheld portable electronic apparatus but as noted above non-handheld portable electronic apparatus' may also be employed.

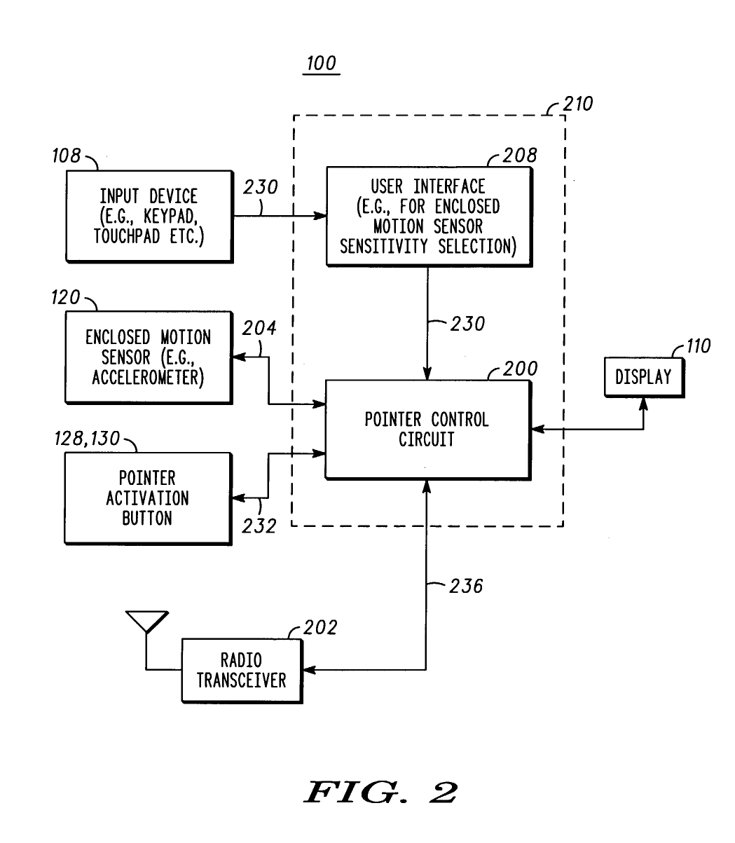

The portable electronic apparatus 100 also includes, in this example, an input device 108 such as keypad, a display 110, an ear cup 112 and a pivot mechanism 114 that couples the base portion 104 and the flip portion 106 in a pivotal position. As known, the display 110 displays a pointer 116, such as a cursor, highlighted text, or other visual indication. The pointer 116 is displayed on display 110 through a pointer control circuit 200 (see FIG. 2). The pointer control circuit may be a conventional pointer control circuit that receives for example cursor control information to control the location of a cursor. Pointer control circuit 200 is operative to control the pointer 116 to facilitate selection of a portion of the display 110 to select for example an icon, or any other suitable item. The display 110 is operatively connected with the pointer control circuit 200 to display the pointer 116.

The portable electronic apparatus 100 includes a motion sensor 120 which is operatively coupled to sense movement of at least a portion of housing 102. In this example, the motion sensor is an enclosed motion sensor 120 that is located inside the housing 102 in the base portion 104 and is located for example on a printed circuit board or other suitable structure within the housing. The housing 102 includes a cover portion 122 positioned to cover the enclosed motion sensor 120. It will be noted that the cover portion 122 in a preferred embodiment is not a removable cover but to the contrary is merely a portion of the housing that covers or encloses the motion sensor so that a user cannot access or contact the enclosed motion sensor 120. Also, dashed box 124 indicates that the enclosed motion sensor 120 may also be located, if desired, in the flip portion 106, or any other suitable portion that enables the enclosed motion sensor 120 to sense movement of the portable electronic apparatus 100, with respect, for example, to a gravitational reference point of the portable electronic apparatus 100.

In this embodiment, the enclosed motion sensor 100 includes an accelerometer that is embodied on an integrated circuit that detects a rate and direction of movement of the portable electronic apparatus 100 such that the pointer control circuit 200 controls movement of the pointer 116 as a function of the detected rate and direction of portable electronic apparatus movement. As such, a user need not use their finger, stylus or other device to control movement of the pointer 116 on a display. The enclosed motion sensor 120 may be for example an X-Y accelerometer that detects the magnitude and direction of movement of the portable electronic apparatus in an xy plane. For example, an xy plane may be a vertical plane with respect to the ground so that if a cell phone is moved in an up down motion a movement in a Y direction is sensed whereas a movement right to left may be sensed as movement in the X direction. Any suitable configuration may be used. Alternatively, the enclosed motion sensor 120 may be a tilt measurement accelerometer. Examples of accelerometers may be for example ADXL05 type accelerometers sold by Analog Devices Inc., an MMA3201D acceleration sensor sold by Motorola Inc., or any other suitable accelerometers.

Alternatively, a gyroscope may be mounted within the housing as an accelerometer to detect motion of the portable electronic apparatus. An example of a suitable gyroscope may be for example, an ADXRS type gyroscope manufactured by Analog Devices Inc., or any other suitable gyroscope. Alternatively, a trackball mechanism mounted within the housing may used to detect motion of the portable electronic apparatus wherein the trackball, like the other embodiments is enclosed within the housing to avoid contact of the motion sensor by a user. As such, unlike conventional devices that employ mice, the disclosed portable electronic apparatus does not have an externally accessible trackball, joystick or other finger controlled mechanism. In addition, the enclosed motion sensor is suitably mounted with respect to the housing of the portable electronic apparatus to detect movement of at least a portion of the portable electronic apparatus to facilitate control of the pointer on the display.

Alternatively one or more tilt sensors may be used as a motion sensor. For example, single axis or dual axis non-linear and linear tilt sensors may be used, such as tilt sensors sold by Fredericks Company.

To facilitate a click and point operation, the portable electronic apparatus 100 also includes, in one example, a bottom surface 126 through which a depressible activation button 128 protrudes from the bottom surface of the housing 102. With this embodiment, a user can push down on the portable electronic apparatus on a hard surface to activate the depressible pointer activation button 128 to facilitate a click operation similar to that of a conventional mouse while moving the device with respect to the gravitational reference point to control movement of the pointer.

In an alternative embodiment, instead of a depressible pointer activation button on a bottom surface of the housing, a side mounted pointer activation surface 130 may be used which includes by way of example, and not limitation, a depressible button, a flat touch activated surface, or any other suitable pointer activation surface located on a side 130 of the housing 102, so that a user when using the handheld device may use a finger to provide the “click” function to facilitate a point and click operation. Although not shown, the pointer activation surface 130 may also be located on top surface 132 of the portable electronic apparatus 100. However, with handheld devices, the surface area of the top or front of the device is often limited due to front keypad 108 or other control buttons. As such, it may preferable to include the pointer activation surface 130 on a side surface of the portable electronic apparatus.

Referring to FIGS. 1-3, one example of the operation of the portable electronic apparatus will be described. FIG. 2 is a block diagram of the portable electronic apparatus 100 and further illustrates that, in this example, the portable electronic apparatus 100 is a communications device that employs a radio transceiver 202 such as a bidirectional cell phone transceiver, a two-way radio transceiver, a two-way pager transceiver, or any other suitable communication transceiver (including optical transceivers). The pointer control circuit 200 may be implemented for example using one or more integrated circuits such as a programmed digital signal processor (DSP), graphics processor, micro controller, host processor, discrete logic, a combination of hardware, software and/or firmware or any other suitable structure as known in the art.

The enclosed motion sensor 120 is coupled to the pointer control circuit 200 through a suitable bus or other connection and generates a pointer control signal 204 that may include analog or digital information in response to detected motion of at least a portion of housing 102. For example, depending upon the location of the enclosed motion sensor 120, movement of the flip portion 106 may be used to control movement of the cursor, or movement of the base portion 104 of the housing may be used to control movement of the pointer. The pointer control signal 204 preferably includes information relating to both rate and direction of movement of the portable electronic apparatus. However, it will be recognized that simply the direction of movement may be output by the enclosed motion sensor 120 depending upon the type of motion sensor used.

When the enclosed motion sensor 120 is an accelerometer, the accelerometer detects the rate and direction of movement of the portable electronic apparatus 100 and the pointer control circuit 200, in response to the pointer control signal 204, controls movement of the pointer 116 as a function of the detected rate and direction of portable electronic apparatus movement.

The portable electronic apparatus 100 may also include a user interface 208 that may be presented for example as a graphic user interface on display 110 to provide user adjustment of the sensitivity of the pointer movement with respect to movement detected by the enclosed motion sensor 120. For example, a portable electronic apparatus controller 210, such as a microprocessor or DSP that may include the pointer control circuit 200 or which may be a different circuit, provides a sensitivity adjustment interface such as a graphic user interface to allow the user to select how sensitive the cursor movement should be based on a movement of the portable electronic apparatus. To illustrate, if a user only wishes to move the portable electronic apparatus a small amount to provide a large distance in cursor movement, the sensitivity interface provides a pull down menu or a graphic bar that a user selects to indicate the level of sensitivity. The pointer control circuit 200 receives the pointer control signal 204 from the enclosed motion sensor 120 in the portable electronic apparatus 100.

The enclosed motion sensor 120 is enclosed in the sense that it is covered by some surface (including a cover) to prevent access by a user of the portable electronic apparatus. The pointer control circuit 200 when receiving the rate and direction from the pointer control signal 204, suitably translates that information based on the sensitivity setting.

Hence, to adjust the sensitivity of the enclosed motion sensor 120, the keypad or other input device 108 is used to generate motion sensor sensitivity control data 230 is provided to the user interface 208. For example, the user interface 208 presents a pull down menu or bar as noted above to select the sensitivity. A user designates the position of a bar or other indication via the keypad 108 to select the motion sensor sensitivity level. The selection of the level of sensitivity is provided as the motion sensor sensitivity control data 230. The motion sensor sensitivity control data 230 is provided via the user interface to the pointer control circuit 200 so that the pointer control circuit 200 can then suitably adjust the sensitivity of the cursor or pointer movement. It will be recognized that the sensitivity may be controlled through any other suitable mechanism such as through a mechanical lever without a user interface.

When switched, the pointer activation button 128, 130 generates activation data 232 indicating whether the button was activated. The activation data 232 is then provided to the pointer control circuit 220 to effect a click operation similar to a conventional mouse device. The display 110, as known in the art, receives pointer location data 234 from the pointer control circuit 200 to position the pointer at the appropriate position on the display 110 and if desired, a rate of change depending upon whether rate of change is provided by the enclosed motion sensor 120.

In the event the radio transceiver 202 is present in the portable electronic apparatus 100, the enclosed motion sensor and pointer activation button may be used to affect data requests and receive information transfers via suitable link 236 so that Internet communication or any other wireless communication may be facilitated.

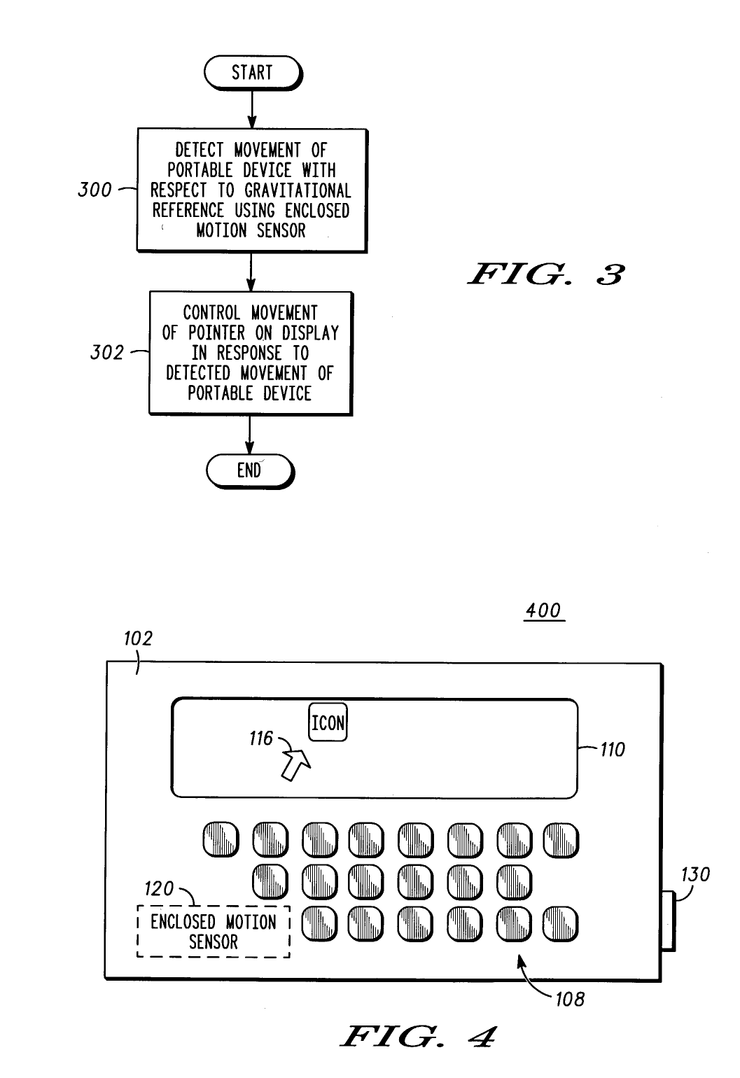

As such, referring to FIG. 3, a method for providing pointer control for a portable electronic apparatus includes detecting movement of the portable electronic apparatus with respect to a gravitational reference point. This is shown in block 300 and may be done, for example, by the enclosed motion sensor 120. The enclosed motion sensor 120 is preferably affixed to the interior of the housing so that when the housing moves, the enclosed motion sensor 120 detects movement of the housing. As shown in block 302, the method included controlling movement of the pointer on the display in response to detected movement of a portion of the portable electronic apparatus. The process is repeated for each movement of the device. As such, movement of the portable electronic apparatus causes the cursor to be moved, as opposed to conventional mice that require a user to manipulate a mechanical structure to cause the cursor to move.

As noted above, the movement sensor may be implemented by incorporating tilt sensors that measure the tilt/inclination of the device with respect to a gravitational axis or reference point. These sensors are typically available in standard DIP/SOT packages and can be reflowed on the PCB. Tilt sensors using many different technologies are available and can be used in this application. Some of the preferred technologies for tilt sensors are: electrolytic type, capacitive, micro-machined acceleration sensors and piezo-based acceleration sensors.

FIG. 4 illustrates another example of a portable electronic apparatus 400 that does not include a radio transceiver 202 and that is not a flip style cell phone. Instead the portable electronic apparatus 400 is meant to illustrate that the disclosed invention is applicable to any suitable portable device whether handheld or non-handheld.

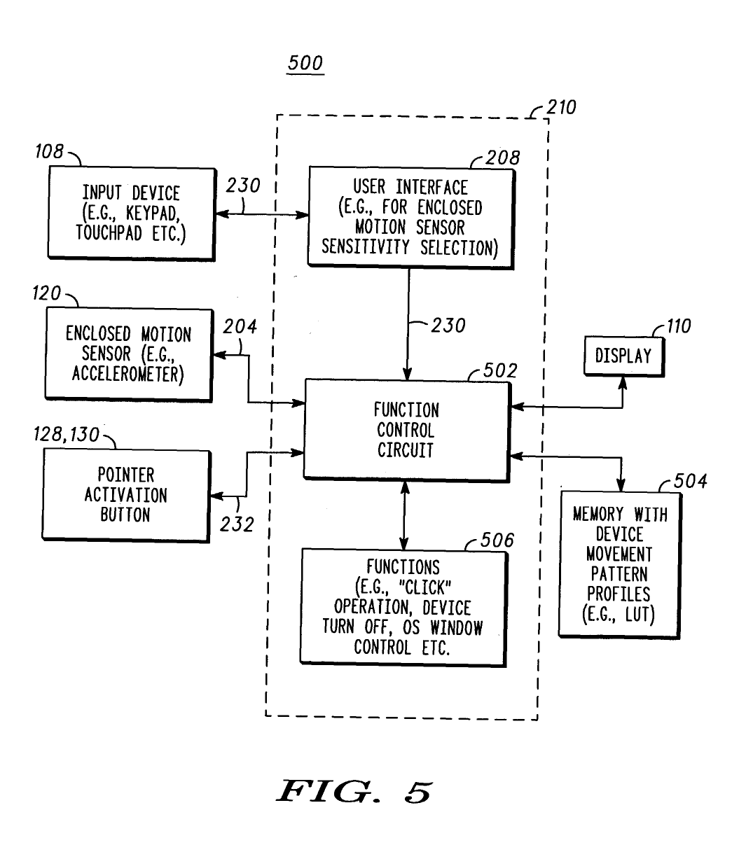

FIG. 5 is a block diagram illustrating another example of a portable electronic apparatus 500 that employs broader functionality than that described above with respect to FIG. 2. For example, in this embodiment, not only does the portable electronic apparatus control pointer movement if desired, but if pointer control is not desired, the portable electronic apparatus 500 controls other functions. As such, the portable electronic apparatus 500 includes a function control circuit 502, that may include for example, the pointer control circuit previously described, and in addition, includes memory 504 that contains data representing motion sensor output profiles associated with an expected apparatus movement pattern. The memory 504 is operatively coupled to the function control circuit 502 through a suitable link. The function control circuit 502 controls functions associated with the device, such as a user interface (e.g. graphic user interface), and in one embodiment, compares the output control signal 204 from the enclosed motion sensor 120 to the data representing the motion sensor output profile to determine if an actual housing movement matches an expected housing movement pattern necessary to effect function control.

For example, a user, through the user interface 208 may configure the portable apparatus 500 to allow the user to shake the device quickly two times to effect, for example, device turn off. The memory 504 contains a motion sensor output profile that is expected when the device is shaken two times. For example, the enclosed motion sensor 120 may output one or more signals (analog or digital) patterns when the device is shaken quickly. These expected patterns may be determined apriori and are stored in memory 504 in a suitable form when the device is manufactured. If, for example, the user wishes to shut the device off and shakes the device, the function control circuit 502 will analyze the control signal 204 and compare it to a signal profile stored in memory 504 to determine whether a proper shaking motion was provided by the user. By way of another example, the windows in a windows-based operating system may be suitably controlled to change the window size to minimize the window or otherwise modify the window as known in the art which is normally done through a “click” operation. Shaking of the device can be as the “click” operation of a mouse thereby avoiding the need to use the pointer activation button 128, 130 for certain device functions. The described function controls are only meant to be examples and not limitations. Any suitable device function may be controlled by movement of the device as desired. An appropriate motion sensor output profile should be stored in memory to detect when the appropriate device motion has been detected. Accordingly, the user interface 208 provides user selection of the device mode so that a user may select whether to use a shaking mode, tilt mode or any other suitable device movement to effect function control. This may be provided for example though a pull-down menu scheme or any other suitable mechanism.

In another embodiment, a teach mode is used to store a custom shake motion for a given function as set by a user through a suitable GUI interface. For example, a user activates a custom shake mode and identifies a function such as a shut off function that is activated based on a particular shaking motion of the device.

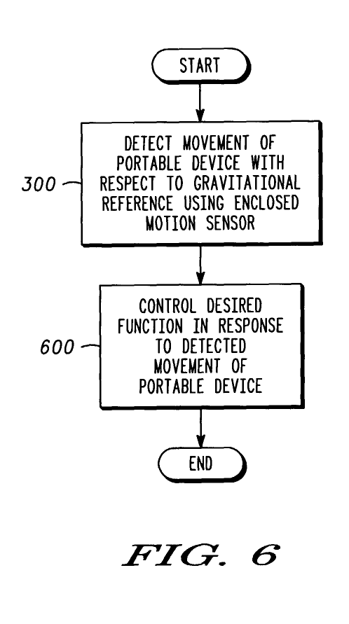

FIG. 6 illustrates another method in accordance with the invention wherein after movement of a portable device is detected, the method, as shown in block 600, includes controlling one or more desired functions in response to detected movement of the portable device. As note above, the functions may include controlling pointer movement, simulating a “click” operation, controlling operating system window control, controlling device on/off function, or any other suitable desired function. In another embodiment, the motion sensor, such as a tilt sensor, may not be enclosed, and as described above is operative to sense movement of at least a portion of the housing with respect to a gravitational reference point and is operatively coupled to the function control circuit. The motion sensor generates the function control signal in response to a detected motion of the at least a portion of the housing. Preferably, the function control circuit includes a user interface so that the user may navigate through screens or menus or may include function buttons that may be activated in response to movement of the device. The method is repeated as needed in response to detected device movement by the motion sensor.

Accordingly, the aforedescribed portable electronic apparatus and method, among other advantages, provides function control through movement of the apparatus. Such function control may include navigational point and click capabilities or other function control. One or more enclosed motion sensors integrated into a portable electronic apparatus detect movement of the device with respect to a gravitational reference point. The movement of the portable electronic apparatus is then used for device function control such as navigating through a menu or making browser selections available on the portable electronic apparatus display. For example, as the user moves the portable electronic apparatus away from themselves, the cursor is moved on the portable electronic apparatus' display upward (or in another suitable direction as desired) with respect to the portable electronic apparatus. The enclosed motion sensor, such as an accelerometer, determines the motion of the portable electronic apparatus and effectively drives the cursor or other suitable pointing device appropriately. The user may then depress or activate a button on the side (or front) or bottom of the portable electronic apparatus to make a mouse selection. The above described methods and apparatus can be added to existing devices that use a mouse, for example, and may share activation buttons.

It should be understood that the implementation of other variations and modifications of the invention in its various aspects will be apparent to those of ordinary skill in the art, and that the invention is not limited by the specific embodiments described. For example, the motion sensor may be enclosed in an accessory device and plugged into a device to be controlled, may be mounted on a printed circuit board and plugged in to a device, or any other suitable coupling arrangement. It is therefore contemplated to cover by the present invention, any and all modifications, variations, or equivalents that fall within the spirit and scope of the basic underlying principles disclosed and claimed herein.

What is claimed is:

1. A portable electronic apparatus comprising:
a housing;
a function control circuit responsive to a function control signal and operative to control a desired function that is performable by the portable electronic apparatus; and
an enclosed motion sensor, operatively coupled to sense movement of at least a portion of the housing and operatively coupled to the function control circuit, that generates the function control signal in response to a detected motion of the at least a portion of the housing.

2. The portable electronic apparatus of claim 1, wherein the function control circuit controls desired function selection based on at least one movement pattern of the housing.

3. The portable electronic apparatus of claim 1, further comprising a display operatively coupled to the function control circuit, wherein the function control circuit controls at least one of: movement of a pointer on the display, a navigation operation and a function selection, in response to movement of the at least a portion of the housing.

4. The portable electronic apparatus of claim 2, further comprising memory, operatively coupled to the function control circuit, containing data representing at least one motion sensor output profile associated with at least one expected apparatus movement pattern; wherein the function control circuit compares the function control signal to the data representing at least one motion sensor output profile to determine if actual housing movement matches an expected housing movement pattern necessary to effect function control.

5. A portable electronic apparatus comprising:
a housing;
a display;
a pointer control circuit, operatively coupled to the display, that, responsive to a pointer control signal, operates to control a pointer to facilitate selection of a portion of the display; and
an enclosed motion sensor, operatively coupled to sense movement of at least a portion of the housing and operatively coupled to the pointer control circuit, that generates the pointer control signal in response to detected motion of the at least a portion of the housing.

6. The portable electronic apparatus of claim 5, wherein the enclosed motion sensor includes an accelerometer that detects a rate and a direction of movement of the portable electronic apparatus and wherein the pointer control circuit controls movement of the pointer as a function of the detected rate and direction of movement.

7. The portable electronic apparatus of claim 5, wherein the housing includes a cover portion positioned to cover the enclosed motion sensor and prevent external contact of the enclosed motion sensor, and wherein the enclosed motion sensor includes at least one of:
an accelerometer;
a gyroscope; and
a tilt sensor.

8. The portable electronic apparatus of claim 5, wherein the housing includes a bottom surface and wherein the portable electronic apparatus further includes a depressible pointer activation button protruding from the bottom surface of the housing.

9. The portable electronic apparatus of claim 5, wherein the housing includes a side surface and a top surface, and wherein the portable electronic apparatus further includes a pointer activation surface on at least one of the top surface and the side surface of the housing.

10. The portable electronic apparatus of claim 5, wherein the pointer control circuit generates a sensitivity adjustment interface to provide user adjustment of a sensitivity of pointer movement with respect to movement detected by the enclosed motion sensor.

11. A portable electronic apparatus comprising:
a housing;
a radio transceiver in the housing;
a display operatively secured to the housing and operatively connected to display a pointer;
a pointer control circuit in the housing, operative to control the pointer to facilitate selection of a portion of the display;
an enclosed motion sensor, operatively coupled to at least a portion of the housing and to the pointer control circuit, that generates a pointer control signal in response to a detected movement of the at least a portion of the housing, the enclosed motion sensor being covered by a cover surface to prevent external contact of the enclosed motion sensor; and
a pointer activation surface located on a surface of the housing and operatively coupled to the pointer control circuit to provide activation of the pointer.

12. The portable electronic apparatus of claim 11, wherein the radio transceiver includes at least one of:
a cellular telephone transceiver, a two way paging transceiver and a two way radio transceiver.

13. The portable electronic apparatus of claim 11, wherein the enclosed motion sensor includes an accelerometer that detects a rate and a direction of movement of the portable electronic apparatus and wherein the pointer control circuit controls movement of the pointer as a function of the detected rate and direction of the detected movement of the at least a portion of the housing.

14. The portable electronic apparatus of claim 11, wherein the enclosed motion sensor includes at least one of:
an X-Y accelerometer or tilt measurement accelerometer mounted within the housing;
a gyroscope mounted within the housing; and
a tilt sensor mounted within the housing.

15. The portable electronic apparatus of claim 14, wherein the housing includes a bottom surface and wherein the pointer activation surface includes a depressible pointer activation button protruding from the bottom surface of the housing.

16. The portable electronic apparatus of claim 11, wherein the housing includes a side surface and wherein the pointer activation surface resides on the side surface of the housing.

17. The portable electronic apparatus of claim 14, wherein the pointer control circuit generates a sensitivity adjustment interface to provide user adjustment of a sensitivity of pointer movement with respect to movement detected by the enclosed motion sensor.

18. A method for providing function control for a portable electronic apparatus comprising:
detecting movement of at least a portion of the portable electronic apparatus using a motion sensor; and
controlling a function performable by the portable electronic apparatus in response to the detected movement of at least a portion of the portable electronic apparatus.

19. The method of claim 18, wherein detecting movement of at least a portion of the portable electronic apparatus includes generating, by the motion sensor, a function control signal to facilitate control of the function and wherein the motion sensor is enclosed within the portable electronic apparatus

20. The method of claim 18, wherein controlling a function performable by the portable electronic apparatus comprises controlling movement of a pointer on a display of the portable electronic apparatus in response to the detected movement of at least a portion of the portable electronic apparatus.

21. A portable electronic apparatus comprising:
a housing;
a function control circuit responsive to a function control signal and operative to control a desired function that is performable by the portable electronic apparatus; and
a motion sensor, operative to sense movement of at least a portion of the housing with respect to a gravitational reference point and operatively coupled to the function control circuit, that generates the function control signal in response to a detected motion of the at least a portion of the housing.

22. The portable electronic apparatus of claim 21 wherein the function control circuit includes a user interface.
